(19) United States
(12) Patent Application Publication
(10) Pub. No.: US 2020/0089426 A1
(43) Pub. Date: Mar. 19, 2020

(54) MANAGEMENT DEVICE, INFORMATION PROCESSING APPARATUS, AND MEMORY CONTROL METHOD

(71) Applicant: KABUSHIKI KAISHA TOSHIBA, Minato-ku (JP)

(72) Inventors: Yusuke SHIROTA, Yokohama (JP); Tatsunori KANAI, Yokohama (JP)

(73) Assignee: KABUSHIKI KAISHA TOSHIBA, Minato-ku (JP)

(21) Appl. No.: 16/287,027

(22) Filed: Feb. 27, 2019

(30) Foreign Application Priority Data
Sep. 14, 2018 (JP) 2018-172870

(51) Int. Cl. G06F 3/06

(52) U.S. Cl. CPC G06F 3/0655; G06F 3/0604; G06F 3/0679

(57) ABSTRACT

According to an embodiment, a management device is for controlling readout and writing of data that are performed by a processing circuit with respect to a non-volatile memory storing a plurality of pages. The non-volatile memory includes a high-temperature region and a low-temperature region in which temperature is relatively lower than in the high-temperature region during operation. The management device includes one or more processors configured to move storage positions of the plurality of pages in such a manner that pages included in a high access page group are stored more in the low-temperature region than in the high-temperature region in the voluntary memory, where the plurality of pages are classified into the high access page group in which access amounts are relatively high, and a low access page group in which access amounts are relatively low.

### CROSS-REFERENCE TO RELATED APPLICATIONS

This application is based upon and claims the benefit of priority from Japanese Patent Application No. 2018-172870, filed on Sep. 14, 2018; the entire contents of which are incorporated herein by reference.

### FIELD

Embodiments described herein relate generally to a management device, an information processing apparatus, and a memory control method.

### BACKGROUND

Recently, a high-speed non-volatile memory referred to as a storage class memory has been developed. In addition to being data-rewritable in a page unit, the storage class memory is data-writable in a unit smaller than the page unit, such as a byte unit, for example. A non-volatile memory that has become data-writable in a byte unit in this manner becomes directly-accessible from a central processing unit (CPU).

Meanwhile, in a case where temperature of a semiconductor device becomes high, an operation needs to be stopped temporarily, or operating frequency needs to be lowered. Thus, in the semiconductor device, operation performance in a region with high temperature has been worsened.

### BRIEF DESCRIPTION OF THE DRAWINGS

FIG. 1 is a diagram illustrating an example of a hardware configuration of an information processing apparatus;

FIG. 2 is a diagram illustrating a configuration of a management device;

FIG. 3 is a diagram illustrating an example of a conversion table;

FIG. 4 is a diagram illustrating the details of first access processing and second access processing;

FIG. 5 is a flowchart illustrating access processing performed by an access processing unit;

FIG. 6 is a diagram illustrating an example of an access amount table;

FIG. 7 is a diagram illustrating a first example of a structure of a non-volatile memory;

FIG. 8 is a diagram illustrating a second example of a structure of a non-volatile memory;

FIG. 9 is a diagram illustrating a third example of a structure of a non-volatile memory;

FIG. 10 is a flowchart illustrating a first example of processing performed by a management unit;

FIG. 11 is a flowchart illustrating a second example of processing performed by the management unit;

FIG. 12 is a diagram illustrating a fourth example of a structure of a non-volatile memory;

FIG. 13 is a diagram illustrating a modified example of identification information;

FIG. 14 is a diagram illustrating a first modified example of a configuration of an information processing apparatus;

FIG. 15 is a diagram illustrating a second modified example of a configuration of an information processing apparatus; and

FIG. 16 is a diagram illustrating a third modified example of a configuration of an information processing apparatus.

### DETAILED DESCRIPTION

According to an embodiment, a management device is for controlling readout and writing of data that are performed by a processing circuit with respect to a non-volatile memory storing a plurality of pages. The management device includes one or more processors. The one or more processors are configured to perform: access processing including performing writing or readout with respect to data stored in the non-volatile memory, in a case where a request for writing or readout is received for any page of the plurality of pages; and management including controlling a storage position in the non-volatile memory for each of the plurality of pages. The non-volatile memory includes a high-temperature region and a low-temperature region in which temperature is relatively lower than in the high-temperature region during operation. The one or more processors are configured to, at the management, move storage positions of the plurality of pages in such a manner that pages included in a high access page group are stored more in the low-temperature region than in the high-temperature region, where the plurality of pages are classified into the high access page group in which access amounts are relatively high, and a low access page group in which access amounts are relatively low.

Hereinafter, an information processing apparatus 10 according to an embodiment will be described in detail with reference to the drawings.

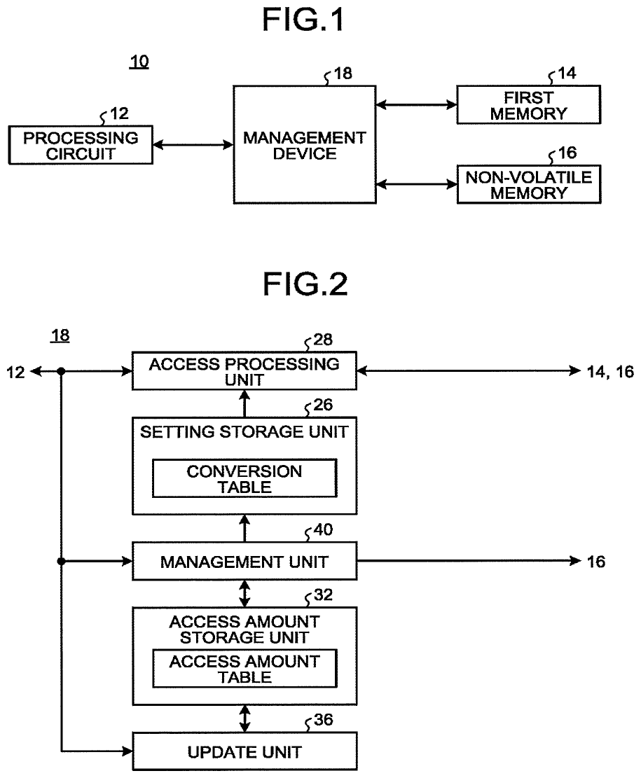

FIG. 1 is a diagram illustrating an example of a hardware configuration of the information processing apparatus 10. The information processing apparatus 10 includes a processing circuit 12, a first memory 14, a non-volatile memory 16, and a management device 18.

The processing circuit 12 includes one or a plurality of processors. For example, the processor is a CPU. The processor may include one or a plurality of CPU cores. The processing circuit 12 processes data by executing a program. In accordance with the execution of the program, the processing circuit 12 reads out data from the first memory 14 or the non-volatile memory 16, or writes data into the first memory 14 or the non-volatile memory 16.

In addition, the processing circuit 12 includes a hierarchical cache memory such as an L1 data cache, an L1 command cache, an L2 cache, and an L3 cache. Using such a cache memory, the processing circuit 12 temporarily stores data stored in the first memory 14 or the non-volatile memory 16. In the case of making a cache mistake in the lowest cache (last-level cache) in the hierarchical caches, for example, the processing circuit 12 accesses the first memory 14 or the non-volatile memory 16 to read out or write in necessary data in a cache line unit.

In addition, the processing circuit 12 may be any circuit as long as data processing can be executed. For example, the processing circuit 12 may be an accelerator or the like. For example, the processing circuit 12 may be a graphics processing unit (GPU) used for a general-purpose computing on graphics processing unit (GPGPU) or the like. In addition, the processing circuit 12 may be an accelerator for artificial intelligence processing, or the like.

The first memory 14 is a main storage device (main memory) used as a work area by the processing circuit 12. The first memory 14 is a volatile memory in which loses stored data when power supply is stopped, for example. The first memory 14 is a Dynamic Random Access Memory (DRAM), for example. In addition, the first memory 14 may be a non-volatile memory such as a Magnetoresistive Random Access Memory (MRAM), to which high-speed access can be performed similarly to the DRAM.

In addition, the first memory 14 has a larger write endurance than that of the non-volatile memory 16. For example, the first memory 14 has such a large number of writable times that design needs not be made considering the number of writable time (e.g. that design can be made assuming that there is no limit on the number of writable times).

The non-volatile memory 16 is a memory that continues to store data even if power supply is stopped. The non-volatile memory 16 functions as a main storage device of the processing circuit 12 together with the first memory 14.

The non-volatile memory 16 includes a large-capacity high-speed non-volatile memory (Non-volatile Memory) having a larger capacity than the DRAM, for example. The non-volatile memory 16 is a MRAM, a phase change memory (PCM), a phase random access memory (PRAM), a phase change random access memory (PCRAM), a resistance change random access memory (ReRAM), a ferroelectric random access memory (FeRAM), a 3DXPoint, a Memristor, or the like, for example. The non-volatile memory 16 may be a memory referred to as a so-called storage class memory (SCM). In addition, the non-volatile memory 16 may be a module in which a plurality of semiconductor devices are provided on one substrate, casing, or the like.

The non-volatile memory 16 has a larger capacity as compared with the first memory 14. The capacity of the non-volatile memory 16 may be the same as that of the first memory 14. In addition, the non-volatile memory 16 has an access speed equivalent to or a bit slower than an access speed of the first memory 14. In addition, the non-volatile memory 16 has zero standby power or extremely-little standby power as compared with the first memory 14. As an example, the non-volatile memory 16 is a memory having an access latency of about 10 nanoseconds to several microseconds.

The non-volatile memory 16 is data-writable and data-readable in a unit of a small region such as a byte unit. Thus, the processing circuit 12 can directly access the non-volatile memory 16 by a load command or a store command. The processing circuit 12 directly accesses the non-volatile memory 16 in a cache line unit or the like, for example.

In addition, the non-volatile memory 16 includes a high-temperature region and a low-temperature region. During operation, temperature in the low-temperature region is relatively lower than in the high-temperature region. For example, in a case where the non-volatile memory 16 includes a plurality of stacked semiconductor chips, a semiconductor chip having good heat release efficiency because of being located close to a heat release device or the like is set as a low-temperature region, and a semiconductor chip having bad heat release efficiency because of being farther from the heat release device or the like is set as a high-temperature region.

The management device 18 controls readout and writing of data that are performed by the processing circuit 12 with respect to the first memory 14 and the non-volatile memory 16. The management device 18 processes an access request to the first memory 14 and the non-volatile memory 16 from the processing circuit 12. More specifically, in response to a writing command from the processing circuit 12, the management device 18 writes data into the first memory 14 or the non-volatile memory 16. In addition, in response to a readout command from the processing circuit 12, the management device 18 reads out data from the first memory 14 or the non-volatile memory 16, and grants the read-out data to the processing circuit 12.

In addition, the management device 18 is a memory controller formed by hardware separate from the processing circuit 12, for example. In addition, the management device 18 may be a part of pieces of hardware of the processing circuit 12 (e.g. circuit formed on the same semiconductor substrate as the processing circuit 12), or may be implemented by a combination of a part of pieces of hardware of the processing circuit 12 and a memory controller. In addition, the management device 18 may be implemented by a part of functions of an operating system executed by the processing circuit 12, or may be implemented by a combination of a part of functions of the operating system, and a memory controller.

In addition, for example, the management device 18 may be a memory management unit (MMU) formed by hardware separate from the processing circuit 12. In addition, the management device 18 may be implemented by a combination of a part of pieces of hardware of the processing circuit 12, and a memory management unit. In addition, the management device 18 may be implemented by a combination of a part of functions of an operating system executed by the processing circuit 12, and a memory management unit.

In addition, the management device 18 may be implemented by a combination of a memory controller and a memory management unit (MMU). In addition, the management device 18 may be implemented by a combination of a part of pieces of hardware of the processing circuit 12, a memory controller, and a memory management unit. In addition, the management device 18 may be implemented by a combination of a part of functions of an operating system executed by the processing circuit 12, a memory controller, and a memory management unit.

FIG. 2 is a diagram illustrating a configuration of the management device 18. The management device 18 includes a setting storage unit 26, an access processing unit 28, an access amount storage unit 32, an update unit 36, and a management unit 40.

The setting storage unit 26 stores a conversion table. The conversion table stores, for each page for which the processing circuit 12 issues an access request, a correspondence relationship between a request address and a number (physical address) for identifying a corresponding region storing a page in the first memory 14 or the non-volatile memory 16.

Furthermore, the conversion table stores, for each page for which the processing circuit 12 issues an access request, an access method indicating which of first access processing and second access processing is to be executed.

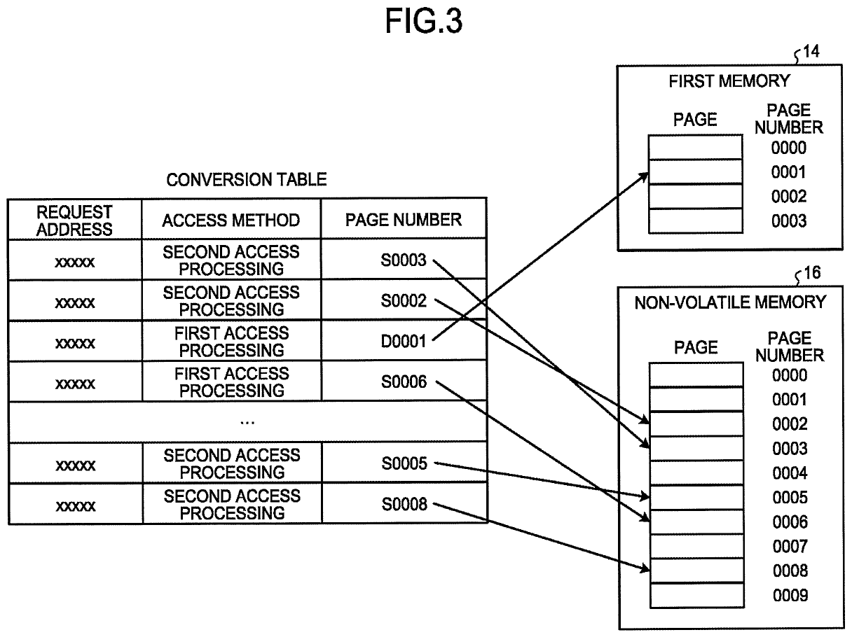

The first access processing is a method of performing writing and readout with respect to data transferred from the non-volatile memory 16 to the first memory 14. The second access processing is a method of directly performing writing and readout with respect to data stored in the non-volatile memory 16. In addition, the details of the conversion table will be described later with reference to FIG. 3.

The access processing unit 28 processes an access request to the first memory 14 and the non-volatile memory 16 from the processing circuit 12. More specifically, in response to a writing command from the processing circuit 12, the access processing unit 28 writes data into the first memory 14 or the non-volatile memory 16. In addition, in response to a readout command from the processing circuit 12, the access processing unit 28 reads out data from the first memory 14 or the non-volatile memory 16, and grants the read-out data to the processing circuit 12.

In addition, for a page for which the processing circuit 12 has issued an access request, the access processing unit 28 accesses the first memory 14 and the non-volatile memory 16 by an access method stored in the conversion table. In other words, in a case where a writing or readout request is received for a page set to the first access processing, the access processing unit 28 executes the first access processing. In addition, in a case where a writing or readout request is received for a page set to the second access processing, the access processing unit 28 executes the second access processing. In addition, the details of the access method will be described later with reference to FIGS. 3, 4, and 5.

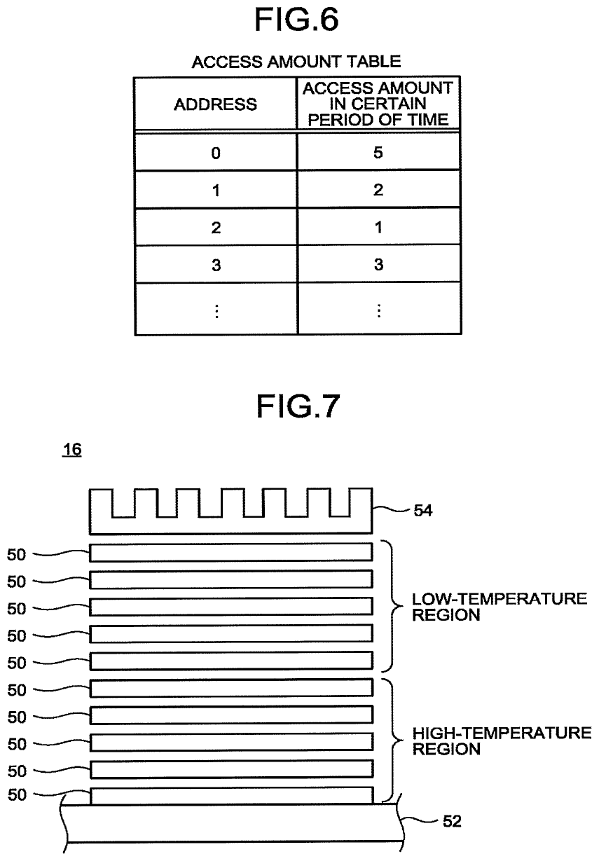

The access amount storage unit 32 stores an access amount table. The access amount table stores, for each of a plurality of pages stored in the non-volatile memory 16, an access amount of data in a certain period of time. In addition, the details of the access amount table will be described later with reference to FIG. 6.

The update unit 36 updates each access amount stored in the access amount table. In a case where the processing circuit 12 accesses the non-volatile memory 16, the update unit 36 acquires address information of accessed data, and updates the access amount table based on the acquired address information. Then, the update unit 36 resets the access amount table every certain period of time.

Here, the access amount is the number of writings in a certain period of time, for example. In this case, the update unit 36 acquires address information of data written into the non-volatile memory 16 by the processing circuit 12, and updates the access amount table based on the acquired address information. In addition, the access amount may be a total number of the number of writings and the number of readouts in a certain period of time. In this case, the update unit 36 acquires address information of data written into the non-volatile memory 16 or read out from the non-volatile memory 16 by the processing circuit 12, and updates the access amount table based on the acquired address information.

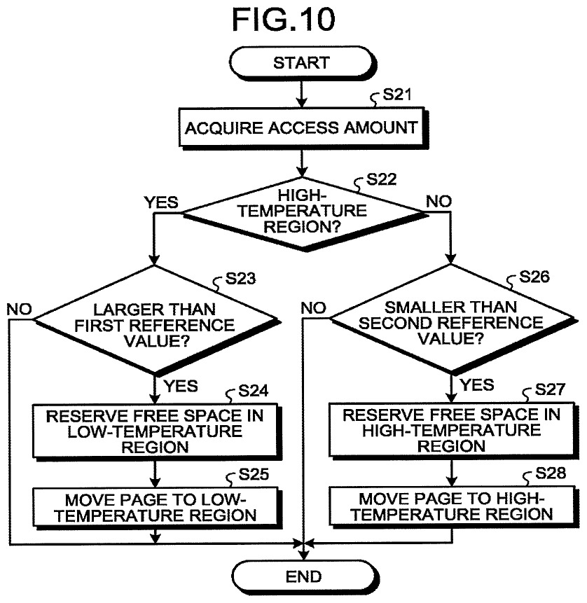

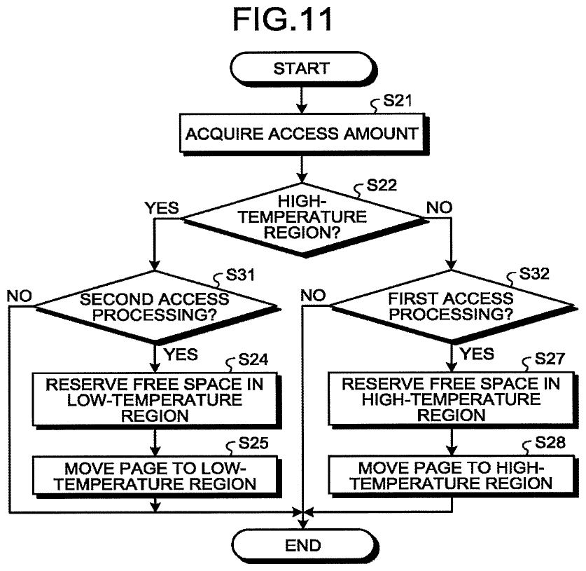

The management unit 40 controls a storage position in the non-volatile memory 16 for each of a plurality of pages. More specifically, in a case where a plurality of pages are classified into a high access page group in which access amounts are relatively high, and a low access page group in which the access amounts are relatively low, the management unit 40 moves storage positions of the plurality of pages in such a manner that pages included in the high access page group are stored more in the low-temperature region than in the high-temperature region. Furthermore, the management unit 40 may move storage positions of the plurality of pages in such a manner that pages included in the low access page group are stored more in the high-temperature region than in the low-temperature region. In addition, detailed processing of the management unit 40 will be further described in FIGS. 10 and 11.

FIG. 3 is a diagram illustrating an example of the conversion table. The conversion table stores, for each page for which the processing circuit 12 issues an access request, a correspondence relationship between a request address and a corresponding page number (physical address) in the first memory 14 or the non-volatile memory 16. In other words, the conversion table stores mapping information indicating in which page in the first memory 14 or the non-volatile memory 16 data corresponding to the request address issued by the processing circuit 12 is stored.

For example, in the example in FIG. 3, a page for which “Sxxxx” is described in the column of a page number in the conversion table indicates a page having a page number “xxxx” in the non-volatile memory 16. For example, in the example in FIG. 3, a page for which “Dxxxx” is described in the column of a page number indicates a page having a page number “xxxx” in the first memory 14. In addition, x here indicates an arbitrary value.

Furthermore, the conversion table stores, for each page for which the processing circuit 12 issues an access request, an access method indicating which of first access processing and second access processing is to be executed. In addition, the configuration of the conversion table is not limited to the configuration as illustrated in FIG. 3, and the conversion table may have another configuration.

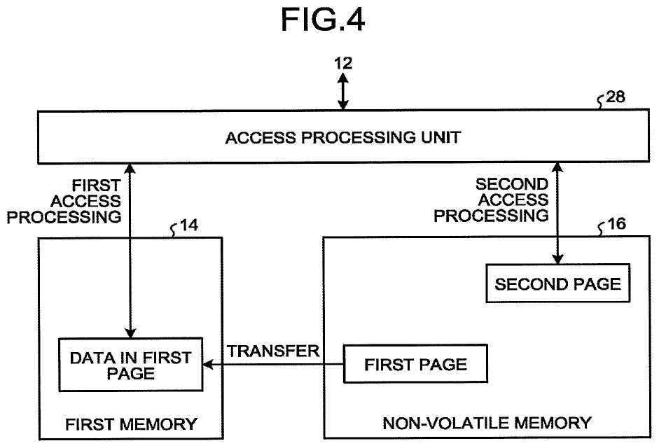

FIG. 4 is a diagram illustrating the details of the first access processing and the second access processing. In a case where a writing or readout request is received for a first page set to the first access processing, the access processing unit 28 executes the first access processing on the non-volatile memory 16.

For example, as illustrated in FIG. 4, in the first access processing, the access processing unit 28 transfers data in the first page that is stored in the non-volatile memory 16, and stores the data in the first memory 14. The first memory 14 can thereby store a copy of the data in the first page that is stored in the non-volatile memory 16. Subsequently, in the first access processing, the access processing unit 28 performs readout and writing with respect to the data in the first page that has been transferred from the non-volatile memory 16 and is stored in the first memory 14. For example, the access processing unit 28 performs readout and writing of data with respect to the data in the first page that has been transferred from the non-volatile memory 16 to the first memory 14, in a size smaller than a page (e.g. cache line size of a processor). Then, in the first access processing, in cases such as a case where a free space of the first memory 14 becomes insufficient, and it becomes impossible to transfer data from the non-volatile memory 16 to the first memory 14, and a case where it is determined that storage in the first memory 14 is unnecessary, the access processing unit 28 writes back the data in the first page that has been transferred to the first memory 14, to the non-volatile memory 16.

In addition, the access processing unit 28 may write back the data in the first page that has been transferred to the first memory 14, to an original location or to another location. For example, in the first access processing, the access processing unit 28 may write back the data in the first page that has been transferred from the non-volatile memory 16 to the first memory 14, to an unused region not associated with any request address. The access processing unit 28 can thereby reduce a gap between the numbers of rewritings among pages, and suppress quality deterioration of a specific page.

In addition, in a case where a writing or readout request is received for a second page set to the second access processing, the access processing unit 28 executes the second access processing on the non-volatile memory 16.

For example, as illustrated in FIG. 4, in the second access processing, the access processing unit 28 directly performs readout and writing with respect to the second page stored in the non-volatile memory 16. For example, the access processing unit 28 performs readout and writing of data in a size smaller than a page.

In this manner, the access processing unit 28 accesses the non-volatile memory 16 by two types of access methods. For example, in a case where an application having high locality is executed for memory access, the access processing unit 28 transfers a page stored in the non-volatile memory 16, to the first memory 14, and accesses the page by the first access processing. The access processing unit 28 can thereby perform processing on the same page at higher speed in a case where an application having high locality is executed for memory access.

In addition, for example, in a case where processing with low locality is executed for memory access as in random access, the access processing unit 28 accesses a page stored in the non-volatile memory 16, by the second access processing. The access processing unit 28 can thereby eliminate an overhead of transfer processing from the non-volatile memory 16 to the first memory 14, and can efficiently perform processing, in a case where processing with low locality is executed. In this manner, the access processing unit 28 can efficiently perform processing by using two types of access methods including the first access processing and the second access processing.

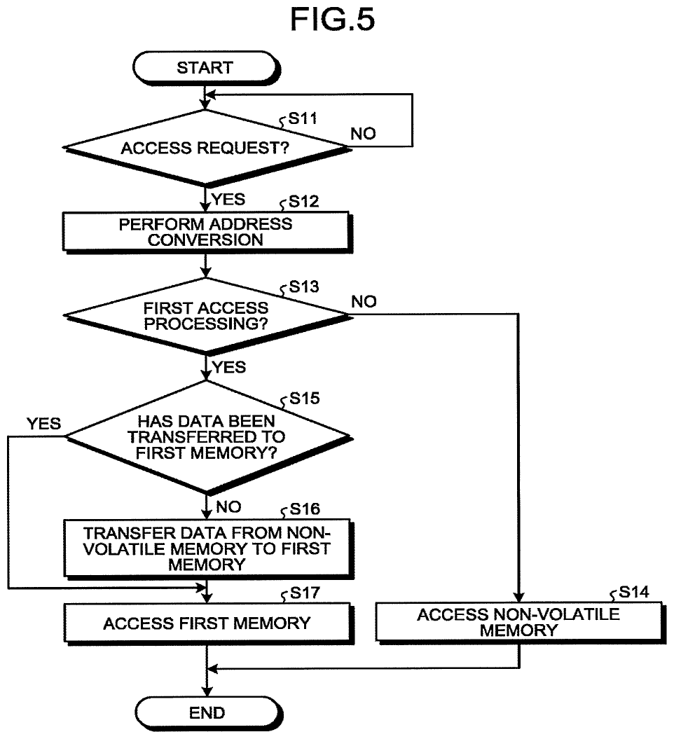

FIG. 5 is a flowchart illustrating access processing performed by the access processing unit 28. According to the flowchart illustrated in FIG. 5, the access processing unit 28 accesses the first memory 14 and the non-volatile memory 16.

First of all, in S11, the access processing unit 28 determines whether an access request is issued from the processing circuit 12. In a case where no access request is issued (No in S11), the access processing unit 28 causes the processing to stand by in S11. In a case where an access request is issued (Yes in S11), the access processing unit 28 advances the processing to S12.

In S12, the access processing unit 28 refers to the conversion table, and identifies, from a request address included in the access request, a page number of a target page serving as an access destination in the first memory 14 or the non-volatile memory 16. The access processing unit 28 can thereby execute address conversion processing from the request address into a physical address.

Subsequently, in S13, the access processing unit 28 determines whether an access method for the target page is the first access processing. In a case where an access method for the target page is not the first access processing, that is to say, in a case where the access method is the second access processing (No in S13), the access processing unit 28 advances the processing to S14. In S14, the access processing unit 28 directly accesses the target page in the non-volatile memory 16. Then, when the processing in S14 ends, the access processing unit 28 ends this flow.

In addition, in a case where an access method for the target page is the first access processing (Yes in S13), the access processing unit 28 advances the processing to S15. In S15, the access processing unit 28 determines whether the data has been transferred to the first memory 14 or the data has not been transferred yet. The access processing unit 28 can determine whether the data has been transferred to the first memory 14 or the data has not been transferred yet, by referring to a page number (physical address) in the conversion table. In a case where the data has been transferred (Yes in S15), the access processing unit 28 advances the processing to S17.

In a case where the data has not been transferred yet (No in S15), the access processing unit 28 advances the processing to S16. In S16, the access processing unit 28 transfers data in the target page to the first memory 14. Furthermore, the access processing unit 28 changes a page number (physical address) of the transferred data in the conversion table, to a page number of a transfer destination in the first memory 14. When the processing in S16 ends, the access processing unit 28 advances the processing to S17.

In S17, the access processing unit 28 accesses the target page in the first memory 14. Then, when the processing in S17 ends, the access processing unit 28 ends this flow. By executing the processing as described above, the access processing unit 28 can access the first memory 14 and the non-volatile memory 16 by an access method stored in the conversion table.

FIG. 6 is a diagram illustrating an example of an access amount table. The access amount table stores, for each of a plurality of pages stored in the non-volatile memory 16, an access amount in a certain period of time. For example, the access amount table stores an access amount in association with an address of each of the plurality of pages stored in the non-volatile memory 16.

Each access amount may represent the number of readouts or an estimate value of the number of readouts of a corresponding page. Each access amount may represent the number of rewritings or an estimate value of the number of rewritings of a corresponding page. Each access amount may represent a total number of the number of writings and the number of readouts of a corresponding page, or a total number of an estimate value of the number of writings and an estimate value of the number of readouts. Each access amount is reset to 0 every certain period of time, for example.

FIG. 7 is a diagram illustrating a first example of a structure of the non-volatile memory 16. For example, the non-volatile memory 16 includes a plurality of stacked chips 50. Each of the plurality of chips 50 can store a plurality of pages. In addition, the plurality of stacked chips 50 is provided on a substrate 52 or an interposer. In addition, a heatsink 54 is provided on the plurality of stacked chips 50.

In the non-volatile memory 16 having such a configuration, heat is released by the heatsink 54. Thus, the non-volatile memory 16 has such a tendency that temperatures of chips 50 in a region close to the heatsink 54 become low, and temperatures of chips 50 in a region far from the heatsink 54 become high. Thus, in the non-volatile memory 16 having such a configuration, one or a plurality of chips 50 far from the heatsink 54 are set as a high-temperature region, and one or a plurality of chips 50 located closer to the heatsink 54 than the high-temperature region are set as a low-temperature region.

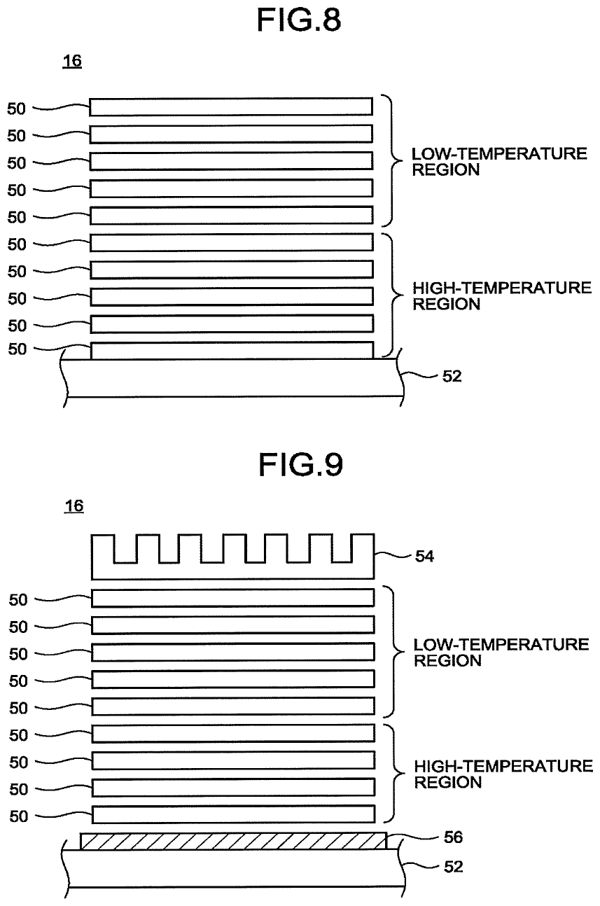

FIG. 8 is a diagram illustrating a second example of a structure of the non-volatile memory 16. As illustrated in FIG. 8, the non-volatile memory 16 may have a configuration in which the heatsink 54 is not provided.

In this case, in the non-volatile memory 16, one or a plurality of chips 50 close to the substrate 52 or the interposer are set as a high-temperature region, and one or a plurality of chips 50 farther from the substrate 52 or the interposer than the high-temperature region are set as a low-temperature region.

FIG. 9 is a diagram illustrating a third example of a structure of the non-volatile memory 16. The non-volatile memory 16 may further include a logic chip 56 provided under or over any one chip 50 of the plurality of chips 50.

The logic chip 56 includes a circuit that executes data processing. The logic chip 56 generally has a large heat generation amount. Thus, in such a non-volatile memory 16, one or a plurality of chips 50 close to the logic chip 56 are set as a high-temperature region, and one or a plurality of chips 50 farther from the logic chip 56 than the high-temperature region are set as a low-temperature region.

FIG. 10 is a flowchart illustrating a first example of processing performed by the management unit 40. The management unit 40 executes, every certain period of time, for example, the processing illustrated in FIG. 10, for each of a plurality of pages stored in the non-volatile memory 16.

In S21, the management unit 40 refers to the access amount table stored in the access amount storage unit 32, and acquires an access amount in a certain period of time in a target page. Subsequently, in S22, the management unit 40 refers to a page number (physical address) in the conversion table in the setting storage unit 26, and determines whether the target page belongs to a high-temperature region. In a case where the target page belongs to a high-temperature region (Yes in S22), the management unit 40 advances the processing to S23, and in a case where the target page does not belong to a high-temperature region (No in S22), the management unit 40 advances the processing to S26.

In S23, the management unit 40 determines whether an access amount in a certain period of time of the target page belonging to the high-temperature region is larger than a predefined first reference value. In a case where the access amount is not larger than the first reference value (No in S23), the management unit 40 ends this flow, and continues the processing of this flow for the next page.

In a case where the access amount is larger than the first reference value (Yes in S23), the management unit 40 advances the processing to S24. In S24, the management unit 40 reserves a free space in the low-temperature region for storing the page. Subsequently, in 325, the management unit 40 moves the target page from the high-temperature region to the low-temperature region, and changes a page number (physical address) of the target page in the conversion table. After ending S25, the management unit 40 ends this flow, and continues the processing of this flow for the next page.

By executing the processing in S24 and S25, the management unit 40 can move storage positions of a plurality of pages in such a manner that pages included in a high access page group are stored more in the low-temperature region than in the high-temperature region.

In addition, in S26, the management unit 40 determines whether an access amount in a certain period of time of a target page not belonging to the high-temperature region, that is to say, a target page belonging to the low-temperature region is smaller than a predefined second reference value. The second reference value is an amount smaller than the first reference value, for example. In a case where the access amount is not smaller than the second reference value (No in S26), the management unit 40 ends this flow, and continues the processing of this flow for the next page.

In a case where the access amount is smaller than the second reference value (Yes in S26), the management unit 40 advances the processing to S27. In S27, the management unit 40 reserves a free space in the high-temperature region for storing the page. Subsequently, in S28, the management unit 40 moves the target page from the low-temperature region to the high-temperature region, and changes a page number (physical address) of the target page in the conversion table. After ending S28, the management unit 40 ends this flow, and continues the processing of this flow for the next page.

By executing the processing in S27 and S28, the management unit 40 can move storage positions of a plurality of pages in such a manner that pages included in a low access page group are stored more in the high-temperature region than in the low-temperature region.

FIG. 11 is a flowchart illustrating a second example of processing performed by the management unit 40. The management unit 40 may execute, every certain period of time, for example, the processing illustrated in FIG. 11, for each of a plurality of pages stored in the non-volatile memory 16. In the processing illustrated in FIG. 11, processing in S31 is executed in place of the processing in S23 of the processing of the first example that is illustrated in FIG. 10, and processing in S32 is executed in place of the processing in 326.

In S31, the management unit 40 refers to an access method in the conversion table in the setting storage unit 26, and determines whether the target page is to be accessed by the second access processing. In a case where the second access processing is not to be used (No in S31), the management unit 40 ends this flow, and continues the processing of this flow for the next page. In a case where the second access processing is to be used (Yes in S31), the management unit 40 advances the processing to S24. The management unit 40 can thereby move the page to the low-temperature region in a case where the second access processing is to be used, that is to say, in a case where processing of directly writing data into or reading data from the non-volatile memory 16 is to be performed.

In addition, in S32, the management unit 40 refers to an access method in the conversion table in the setting storage unit 26, and determines whether the target page is to be accessed by the first access processing. In a case where the first access processing is not to be used (No in S32), the management unit 40 ends this flow, and continues the processing of this flow for the next page. In a case where the first access processing is to be used (Yes in S32), the management unit 40 advances the processing to S27. The management unit 40 can thereby move the page to the high-temperature region in a case where the first access processing is to be used, that is to say, in a case where processing of performing writing and readout of data by copying the data into the first memory 14 is to be performed.

In place of the above-described processing, in S31, the management unit 40 may determine whether the target page is to be accessed by the first access processing. Then, in a case where the first access processing is to be used (Yes in S31), the management unit 40 advances the processing to S24. The management unit 40 can thereby move the page to the low-temperature region in a case where the first access processing is to be used, that is to say, in a case where an access amount with respect to the page is large.

Furthermore, in S32, the management unit 40 may determine whether the target page is to be accessed by the second access processing. Then, in a case where the second access processing is to be used (Yes in 332), the management unit 40 advances the processing to 327. The management unit 40 can thereby move the page to the high-temperature region in a case where the second access processing is to be used, that is to say, in a case where an access amount with respect to the page is small.

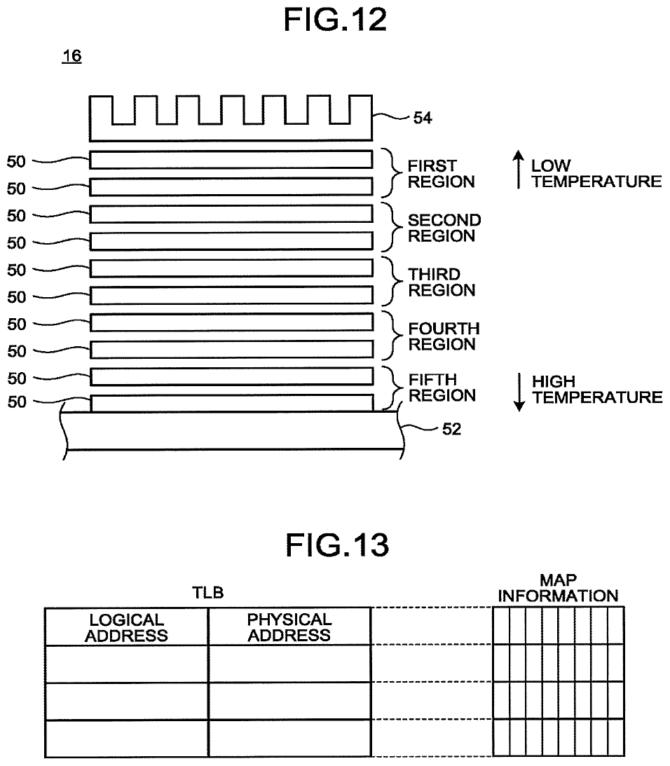

FIG. 12 is a diagram illustrating a fourth example of a structure of the non-volatile memory 16. In the non-volatile memory 16, three or more regions may be set between the high temperature side (e.g. the far side from the heatsink 54, the close side to the substrate 52 or the interposer, or the close side to the logic chip 56) and the low temperature side (e.g. the close side to the heatsink 54, the far side from the substrate 52 or the interposer, or the far side from the logic chip 56).

In such a case, for example, the management unit 40 classifies access amounts with respect to target pages, into a plurality of stages, and moves the target pages to regions corresponding to the respective classifications. Specifically, the management unit 40 moves the target pages so as to be stored in a region closer to the low temperature side as the access amounts become larger. In other words, the management unit 40 moves the target pages so as to be stored in regions closer to the high temperature side as the access amounts become smaller.

Also in this case, the management unit 40 can move storage positions of the plurality of pages in such a manner that pages included in the high access page group are stored more in the low-temperature region than in the high-temperature region. Furthermore, the management unit 40 can move storage positions of the plurality of pages in such a manner that pages included in the low access page group are stored more in the high-temperature region than in the low-temperature region.

As describe above, the information processing apparatus 10 according to the present embodiment can store a page with a large access amount in a low-temperature region, and store a page with a small access amount in a high-temperature region. There is a possibility that operation performance becomes worse in the high-temperature region than that in the low-temperature region. Thus, by storing a page with a large access amount in the low-temperature region, the information processing apparatus 10 according to the present embodiment can enhance access efficiency with respect to the non-volatile memory 16 as a whole.

### Modified Example

Hereinafter, modified examples of each embodiment will be described.

FIG. 13 is a diagram illustrating a modified example of identification information. The management device 18 identifies management information stored in a management table, using a page number. In place of this, the management device 18 may identify management information stored in a management table, by associating the management information with an address managed by a Translation Lookaside Buffer (TLB).

The processing circuit 12 includes a virtual storage mechanism referred to as a TLB. The TLB stores correspondence relationship information indicating correspondence between a request address (logical address) and a physical address in a page, for converting an address from a virtual address to a physical address. Nevertheless, the correspondence relationship information is replaced as necessary because entries held by the TLB are limited. The TLB preferentially stores correspondence relationship information regarding pages recently accessed at high frequency, for example.

Thus, the management device 18 may store management information in a management table for a page for which correspondence relationship information is stored in the TLB. For example, the management device 18 stores a management table including entries in the same number as the number of entries of the TLB. Then, the update unit 36 erases management information stored in a corresponding management table, at a timing at which correspondence relationship information is expelled from the entries of the TLB. In this case, the update unit 36 executes processing similar to that executed in a case where management information is written into another pieces of management information. In addition, because a management table includes the same entries as the entries of the TLB, an entry storing identification information needs not be included.

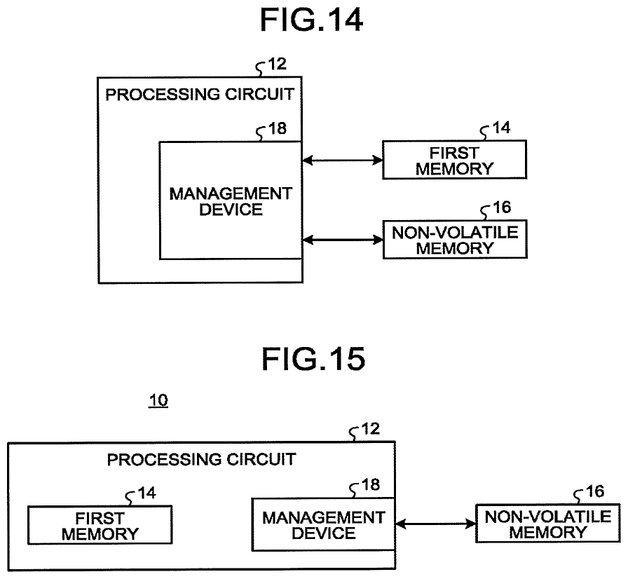

FIG. 14 is a diagram illustrating a first modified example of a configuration of the information processing apparatus 10. For example, the processing circuit 12 according to the first modified example includes the management device 18 thereinside. The first memory 14 and the non-volatile memory 16 according to the first modified example are provided on the outside of the processing circuit 12.

FIG. 15 is a diagram illustrating a second modified example of a configuration of the information processing apparatus 10. For example, the processing circuit 12 according to the second modified example includes the management device 18 thereinside. The processing circuit 12 according to the second modified example also includes the first memory 14 thereinside.

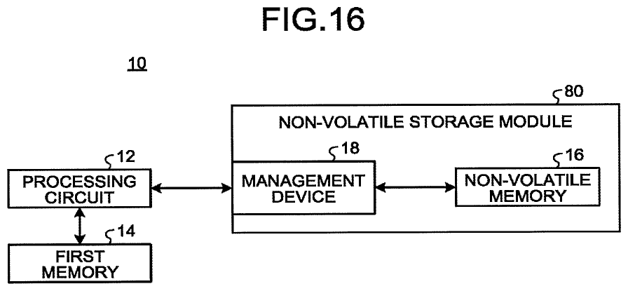

FIG. 16 is a diagram illustrating a third modified example of a configuration of the information processing apparatus 10. For example, the information processing apparatus 10 may include the processing circuit 12 and a non-volatile storage module 80. In this case, the non-volatile storage module 80 includes the non-volatile memory 16 and the management device 18.

In addition, the first memory 14 may be a Static Random Access Memory (SRAM) in a processor, for example. In addition, the first memory 14 may be a non-volatile memory such as a MRAM that has a larger number of rewritings than that of the non-volatile memory 16.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A management device for controlling readout and writing of data that are performed by a processing circuit with respect to a non-volatile memory storing a plurality of pages, the management device comprising:
one or more processors configured to perform:
access processing including performing writing or readout with respect to data stored in the non-volatile memory, in a case where a request for writing or readout is received for any page of the plurality of pages; and
management including controlling a storage position in the non-volatile memory for each of the plurality of pages, wherein
the non-volatile memory includes a high-temperature region and a low-temperature region in which temperature is relatively lower than in the high-temperature region during operation, and
the one or more processors are configured to, at the management, move storage positions of the plurality of pages in such a manner that pages included in a high access page group are stored more in the low-temperature region than in the high-temperature region, where the plurality of pages are classified into the high access page group in which access amounts are relatively high, and a low access page group in which access amounts are relatively low.

2. The device according to claim 1, wherein the one or more processors are configured to, at the management, move storage positions of the plurality of pages in such a manner that pages included in the low access page group are stored more in the high-temperature region than in the low-temperature region.

3. The device according to claim 1, wherein the access amounts are the numbers of writings in a certain period of time.

4. The device according to claim 1, wherein the access amounts are total numbers of the numbers of writings and the numbers of readouts in a certain period of time.

5. The device according to claim 1, wherein the one or more processors are configured to, at the management, move, to the low-temperature region, a page with an access amount larger than a first reference value, among the plurality of pages.

6. The device according to claim 2, wherein the one or more processors are configured to, at the management, move, to the high-temperature region, a page with an access amount smaller than a second reference value, among the plurality of pages.

7. The device according to claim 1, wherein
heat is released by a heatsink from the non-volatile memory, and
the low-temperature region is closer to the heatsink than the high-temperature region.

8. The device according to claim 1, wherein
the non-volatile memory includes a plurality of chips stacked on a substrate or an interposer, and
the low-temperature region is farther from the substrate or the interposer than the high-temperature region.

9. The device according to claim 1, wherein
the non-volatile memory further includes a plurality of chips and a logic chip provided under or over any one chip of the plurality of chips, and
the low-temperature region is farther from the logic chip than the high-temperature region.

10. The device according to claim 1, wherein the one or more processors are configured to, at the management, control readout and writing of data that are performed by the processing circuit with respect to a first memory and the non-volatile memory.

11. The device according to claim 10, wherein
the one or more processors are further configured to store, for each of the plurality of pages, an access method indicating which of first access processing of performing writing and readout with respect to data transferred from the non-volatile memory to the first memory, and second access processing of directly performing writing and readout with respect to data stored in the non-volatile memory is to be executed, and
the one or more processors are configured to, at the access processing, execute the first access processing in a case where a request for writing or readout is received for a page set to the first access processing, and execute the second access processing in a case where a request for writing or readout is received for a page set to the second access processing.

12. The device according to claim 11, wherein the one or more processors are configured to, at the management, store a page for which the access method is set to the second access processing, in the low-temperature region.

13. The device according to claim 11, wherein the one or more processors are configured to, at the management, store a page for which the access method is set to the first access processing, in the low-temperature region.

14. An information processing apparatus comprising:
the processing circuit;
the first memory;
the non-volatile memory; and
the management device according to claim 10.

15. A memory control method performed by a management device for controlling readout and writing of data that are performed by a processing circuit with respect to a non-volatile memory storing a plurality of pages, the non-volatile memory including a high-temperature region and a low-temperature region in which temperature is relatively lower than in the high-temperature region during operation, the memory control method comprising:
performing writing or readout with respect to data stored in the non-volatile memory, in a case where a request for writing or readout is received for any page of the plurality of pages; and
moving storage positions of the plurality of pages in such a manner that pages included in a high access page group are stored more in the low-temperature region than in the high-temperature region, where the plurality of pages are classified into the high access page group in which access amounts are relatively high, and a low access page group in which the access amounts are relatively low.
